(19) United States
(12) Patent Application Publication
(10) Pub. No.: US 2018/0272300 A1
(43) Pub. Date: Sep. 27, 2018

(54) BLENDER INCLUDING AN INTEGRATED SCALE

(71) Applicant: Perfect Company, Vancouver, WA (US)

(72) Inventors: Michael Wayne Wallace, Vancouver, WA (US); Philip Trevor Odom, Portland, OR (US)

(21) Appl. No.: 15/467,110

(22) Filed: Mar. 23, 2017

(51) Int. Cl. B01F 15/00; B01F 13/10; B01F 7/20; B01F 7/16; B02C 18/12; B02C 25/00

(52) U.S. Cl. CPC B01F 15/00194; B01F 13/1041; B01F 13/1066; B01F 7/20; B01F 2013/108; B01F 15/00305; B02C 18/12; B02C 25/00; B01F 7/162

(57) ABSTRACT

A blender includes an integrated scale that may be used to weigh ingredients added to the blender. The integrated scale is configured and mounted atop the blender to allow for a vessel that receives ingredients to sit apart from a motor clutch mechanism of the blender when measuring ingredients. The integrated scale is also designed and mounted to allow the vessel to engage with the motor of the mixing apparatus when blending and/or mixing ingredients, while not engaging the integrated scale.

### BACKGROUND

Apparatuses that blend, mix, cut, chop, etc., various ingredients include, for example, blenders, mixers, food processors, spice grinders, coffee grinders, etc. When such apparatuses are being utilized to blend and/or mix ingredients, recipes for the blending and/or mixing of the ingredients are generally measured by volume. However, measuring a cup of fresh spinach or a cup of ice cubes and obtaining a consistent result after blending may be difficult. This may be due to, for example, measuring odd sized ingredients by volume. More particularly, recipes may call for a whole banana, a half of an avocado, etc. However, produce generally varies by size, shape and weight. Thus, in order to achieve consistency for recipes, measuring ingredients by weight may allow for one to accurately measure ingredients for consistency in utilizing the recipe and in tracking nutritional information.

However, small appliances such as, for example, blenders and food processors, that have included built-in scales for weighing ingredients generally utilize load cells that are mounted in the base of the blender or food processor below the motor. Therefore, the load cells take the full weight of the appliance onto a surface such as the countertop on which the appliance is resting. The constant weight and vibration from the motor stresses the load cells and may cause failure over time. Additionally, a load cell built for abuse provided by such a design may not be precise enough to measure very small amounts of ingredients.

Other designs for blenders and food processors attempt to measure weight when the blender or food processor container is sitting atop and engaged with the motor clutch assembly. Such an approach may avoid the problem of mounting load cells below the motor, but will still have a mechanical connection with the motor. Such a connection is not ideal as mechanical isolation is generally key for optimal load cell performance.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIGS. 1A-1C schematically illustrate an example of a mixing apparatus that includes an integrated scale, in accordance with various configurations.

FIG. 2 schematically illustrates a vessel arranged on the integrated scale, in accordance with various configurations.

FIG. 3 schematically illustrates coupling a coupling unit to the vessel, in accordance with various configurations.

FIG. 4 schematically illustrates another vessel arranged on the integrated scale, in accordance with various configurations.

FIGS. 5A-5D schematically illustrate another example of a mixing apparatus that includes an integrated scale, in accordance with various configurations.

FIG. 6 is a flowchart illustrating an example method of determining a number of subscribers to the wireless communication network of FIG. 1 that access the wireless communication network via the (WLAN), in accordance with various configurations.

### DETAILED DESCRIPTION

Described herein is a blender with an integrated scale. The integrated scale is configured and mounted atop a mixing apparatus to allow for a vessel that receives ingredients to sit apart from a motor clutch mechanism of the mixing apparatus when measuring ingredients. The integrated scale is also designed and mounted to allow the vessel to operatively engage with the motor of the mixing apparatus when blending and/or mixing ingredients, while not engaging the integrated scale. While the present disclosure describes aspects herein with respect to a mixing apparatus such as, for example, a blender, it is to be noted that similar appliances that utilize a container sitting on top of a base that includes a motor may also benefit from the concepts disclosed herein to implement an integrated scale. Examples include, but are not limited to, mixers, food processors, spice grinders, coffee grinders, etc.

In accordance with configurations, a load cell assembly is mounted on top of a motor enclosure (base) of an apparatus such as, for example, a blender, food processor or similar appliance. The load cell assembly generally surrounds a spinning motor connection, which is often referred to as a clutch, through which the agitator, e.g., mixing blade, operatively engages with the motor.

In accordance with configurations, the vessel does not engage with the motor clutch while the vessel is sitting on the integrated scale. The shape of the integrated scale surface is generally designed in concert with the vessel shape to allow the vessel to sit on the load cells of the integrated scale in one orientation and then to engage the motor clutch while in a different orientation, e.g., by moving or rotating the vessel vertically (i.e. flipping) with respect to the base.

In accordance with configurations, the orientation may be rotationally centered around the motor clutch. In such a configuration, the vessel may be moved or rotated horizontally with respect to the motor clutch so that the vessel no longer engages the integrated scale and engages the motor clutch. In accordance with other configurations, the vessel may be moved or rotated vertically with respect to the motor clutch so that the vessel no longer engages the integrated scale and instead engages the motor clutch. In configurations, vessels may be designed such that the vessels can be moved in multiple directions, e.g., vertically and/or horizontally, with respect to the base such that the vessels may engage and disengage the integrated scale, as well as engage and disengage the motor clutch.

When the vessel is mounted atop the mixing apparatus and in contact with the scale, the contents provided in the vessel may be weighed. In one scenario, a user may add ingredients while the vessel sits on the mixing apparatus and the scale measures the weight as the ingredients are added.

In another example, the user may add ingredients to a vessel that is open at the top and then place the vessel on the mixing apparatus such that the vessel is in contact with the scale. If a recipe the user is following requires multiple ingredients, the user may add all ingredients to the vessel all at once and then place the vessel on the scale, or may remove the vessel from the mixing apparatus to add subsequent ingredients and then replace the vessel on the mixing apparatus such that the vessel is in contact with the scale. A recipe being followed by the user may be altered by the mixing apparatus each time the vessel is replaced on the mixing apparatus and the scale to maintain the proportions among the ingredients of the recipe. Once all ingredients have been added, a lid may be placed over the open end to close the vessel.

In configurations, the ingredients and weights for ingredients may be provided in feedback to the user via a user interface (UI) that may utilize audio/visual (A/V) techniques via one or more of a display, a microphone, speakers, keyboard, etc. on the apparatus. The feedback/UI can further be implemented as a graphic user interface (GUI) on a display that may be integrated into the base or provided as a separate UI app running on a separate electronics device.

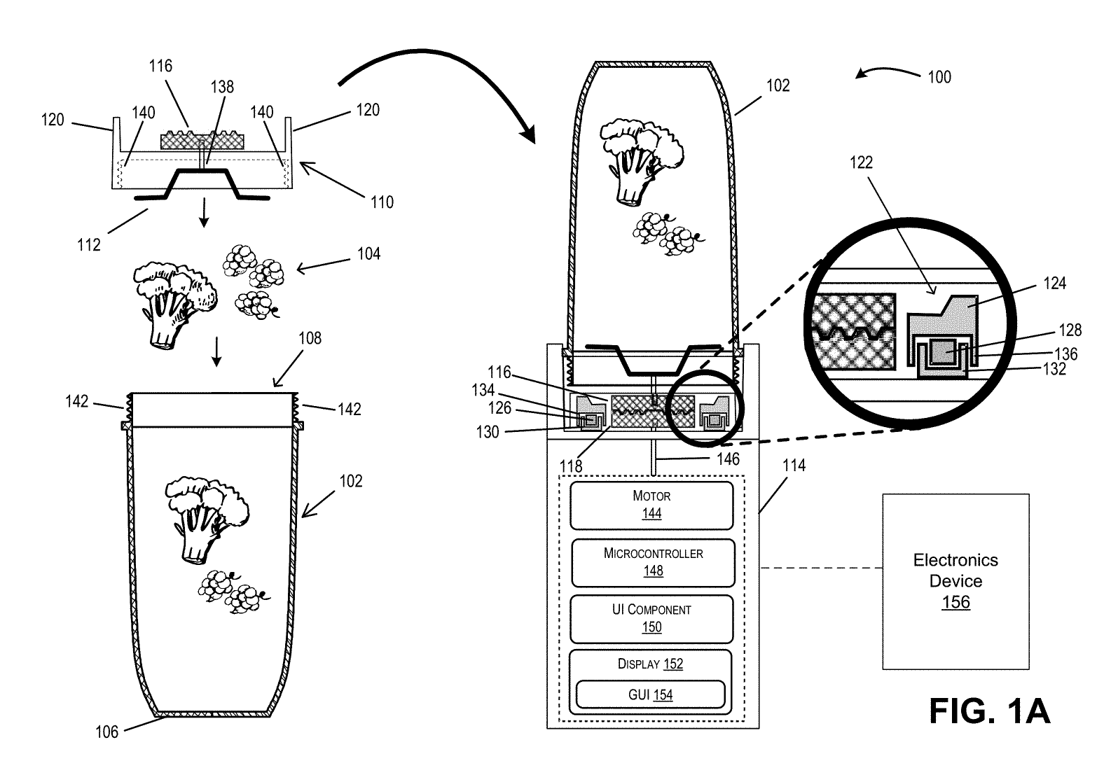

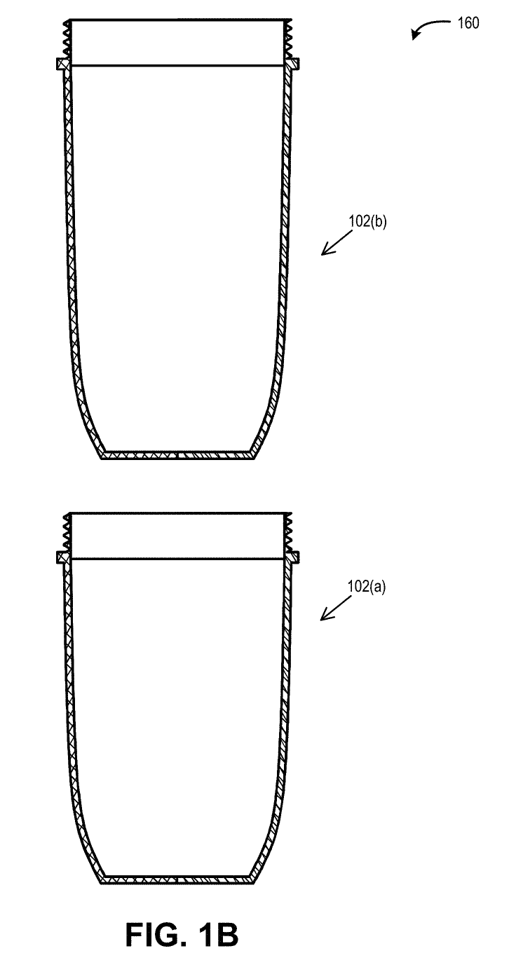

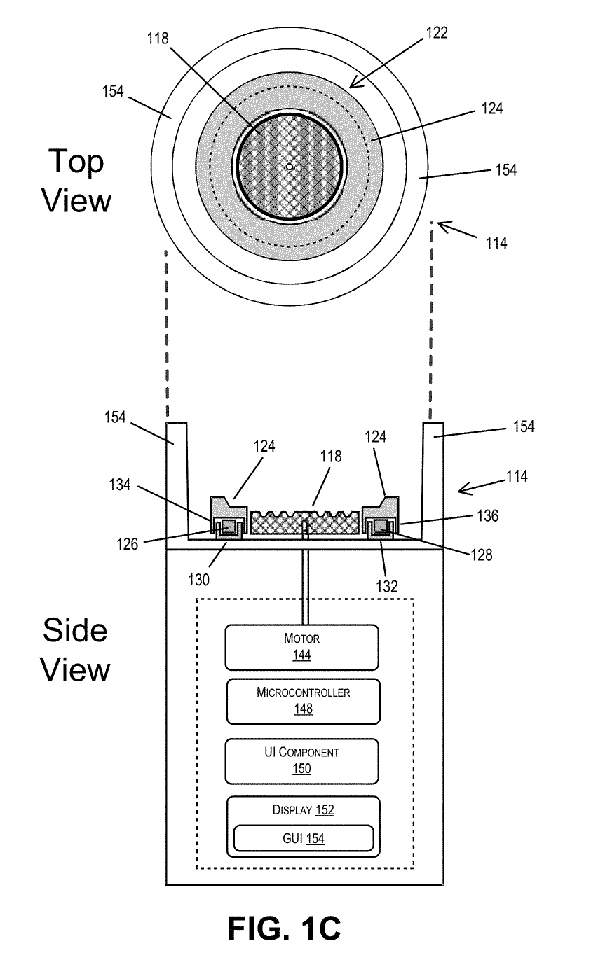

FIGS. 1A-1C schematically illustrate an example of a mixing apparatus 100 in the form of a blender that includes a vessel 102 for receiving ingredients 104. The illustrated example blender is generally a type referred to as a personal blender. Personal blenders generally use a vessel 102 in the form of a blender cup with one enclosed end 106 and one opposing open end 108 to form a structure like a cup or bowl. Thus, the vessel 102 may be referred to as a blender cup 102 herein with reference to the example arrangements of FIGS. 1-4.

Ingredients 104 are added through the open end 108. A separate coupling unit 110 that includes an agitator 112, which may be in the form of a blender blade or mixing blade, is then attached to the blender cup 102 at the open end 108. In this manner, the coupling unit 110 effectively functions as a lid for the blender cup 102, enclosing the ingredients within the vessel. The entire blender cup 102 and the attached coupling unit 110 is moved horizontally relative to a base 114 or inverted and placed on the base 114. The coupling unit 110 includes a coupling clutch plate 116 that engages with a motor clutch plate 118 of the base 114.

In accordance with configurations, an integrated scale 122 is included on the base 114 around the motor clutch plate 118. The integrated scale 122 includes a plate 124 and two load cells 126, 128 that are located on opposite sides of the base 114. The load cells 126, 128, as may be seen in FIGS. 1A and 1C, are held in place on the base 114 in brackets 130, 132. At least a portion of the plate 124 includes extensions 134, 136 that extend on and over sides of the brackets 130, 132 to help protect the load cells 126, 128. In configurations, four load cells may be included if desired, where the four load cells are arranged around the integrated scale 122 such that the first two load cells 126, 128 are located opposite to one another and the other two load cells are located opposite to one another and offset by 90 degrees with respect to the load cells 126, 128. In configurations, there may be more or fewer load cells, e.g., three load cells, five load cells, etc. Additionally, in configurations, the load cells may be arranged and offset from each other by different angles than 90 degrees. Also, in configurations, the load cells may be arranged and offset from each other by varying amounts, e.g., not a constant 90 degrees.

As can be seen in FIG. 1A, the agitator 112 is coupled to an axis 138 that is coupled to the coupling clutch plate 116. The coupling unit 110 further includes threads 140 defined within an inner portion of the coupling unit 110 that cooperate with threads 142 of the blender cup 102 to couple the blender cup 102 to the coupling unit 110. The coupling unit 110 and the blender cup 102 may be coupled together by “screwing” the cooperating threads 140, 142 together. This may be achieved by rotating one or both of the blender cup 102 and/or the coupling unit 110 relative to one another. Isolation walls 120 are also included on the coupling unit 110 that isolate the coupling clutch plate 116, as will be further described herein.

The base 114 includes a motor 144 that is operatively coupled to an axis 146. The axis 146 is coupled to the motor clutch plate 118. Thus, during operation of the mixing apparatus 100, the motor 144 rotates the axis 146, which rotates the motor clutch plate 118. Since the motor clutch plate 118 is engaged with the coupling clutch plate 116, the coupling clutch plate 116 also rotates, which rotates the axis 138 to thereby rotate the agitator 112 and mix and/or blend the ingredients 104 in the blender cup 102.

The base 114 may also include one or more of a microcontroller 148 and a user interface (UI) component 150 that provides feedback or instructions to the user as the user fills the vessel with ingredients and the scale outputs measurements. The UI component 150 may alternatively or additionally provide directions associated with how to operate the device. The UI component 150 may be implemented utilizing audio/visual (A/V) techniques and components via one or more of a display, microphone, keyboard, speakers, etc. to provide audio and/or visual feedback.

Accordingly, depending upon implementation, the base 118 may be further equipped with a display 152, a graphic user interface (GUI) 154 depicted or presented on the display, as will be discussed further herein. The GUI 154 may be part of the display 152 in configurations as illustrated, or may be separate from the display 152, if desired. For instance, the GUI 154 may be executed on a separate electronics device 156 that is communicatively coupled to the mixing apparatus 100 via, for instance, short range communication protocols such as Bluetooth®. Examples of such an electronics device 156 include, but are not limited to, mobile telephones, cellular telephones, mobile computers, Personal Digital Assistants (PDAs), radio frequency devices, handheld computers, laptop computers, tablet computers, palmtops, as well as desktop computers, devices configured as Internet of Things (IoT) devices, integrated devices combining one or more of the preceding devices, and/or the like.

In configurations, the UI component 150 and the GUI 154 may be a single component depending upon the implementation of the UI component 150 and the GUI 154. Thus, the UI component 150 may comprise the display 152 and the GUI 154. In configurations, one or more manual or physical controls (not illustrated) may also be included on the base 114, if desired.

As can be seen in FIG. 1B, in configurations, the mixing apparatus 100 may include multiple blender cups 102a, 102b. The multiple blender cups 102a, 102b may generally be of differing sizes and/or shapes.

FIG. 1C schematically illustrates a side view and a top view of the base 114 of the mixing apparatus 100. Isolation walls 154 of the base 114 extend around an outer periphery of the base 114. As can be seen, the base 114 generally has a circular cross-sectional shape, although in other configurations, the base 114 may have a different cross-sectional shape. As can also be seen in FIG. 1C, the plate 124 of the integrated scale 122 has a ring shape or circular shape and generally surrounds the motor clutch plate 118, although other shapes may be utilized if desired. In accordance with configurations, the blender cup 102 is also generally round or circular in cross-sectional shape like the plate 124 of the integrated scale 122. However, other shapes may be utilized if desired.

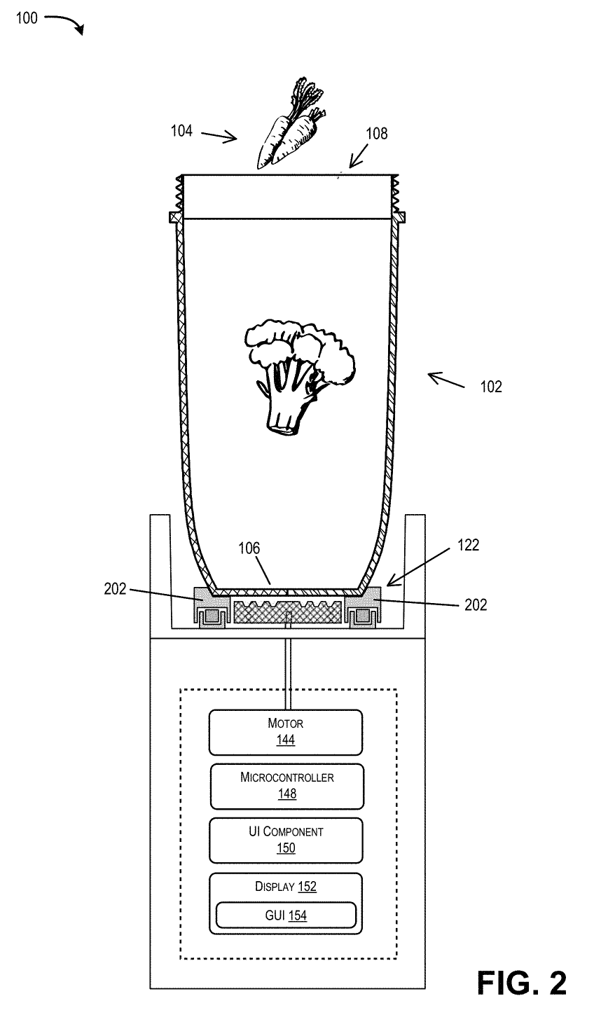

FIG. 2 schematically illustrates the blender cup 102 resting on the integrated scale 122 by placing the closed end 106 of the blender cup 102 on the plate 124 of the integrated scale 122. As may be seen in FIG. 2, the plate 124 may include a raised edge 202 to help register/center the blender cup 102 on the plate 124. The raised edge 202 may also help keep the blender cup 102 stable as ingredients 104 are added to the blender cup 102. As may be seen in FIG. 2, while the blender cup 102 is resting on the plate 124, the blender cup 102 is not engaged with the motor clutch plate 118 and is sitting above the motor clutch plate 118.

As ingredients 104 are added to the blender cup 102, the weight of the ingredients 104 added to the blender cup 102 may be ascertained by the integrated scale 122. The information regarding the weight of the ingredients 104 added to the blender cup 102 may be provided to the microcontroller 148 and can be displayed on the display 152 and/or may be audibly provided by the UI component 150 so that a user may see and/or hear the weight of ingredients 104 as they are added. The weight displayed on the display may be per ingredient or may be an accumulated total weight. More particularly, analog voltage values from the load cells 126, 128 of the integrated scale 122 may be provided to an analog-to-digital converter (ADC) that may be included in the microcontroller 148. In configurations, the ADC is separate from the microcontroller 148. The ADC converts the analog voltage values to digital values. The digital voltage values are converted to weights by the microcontroller 148 using stored calibration data.

In configurations, when the weight displayed is per ingredient, the user may indicate, either through the UI component 150, the GUI 154 or physical controls, that a new ingredient is now being added. Alternatively, if a recipe is being followed and the recipe is included within, or at least being monitored by, the microcontroller 148, then as ingredients are added and the appropriate amount of ingredient based upon weight has been reached, then the microcontroller 148 may inform the user, via the UI component 150 and/or the GUI 154, to begin adding a subsequent ingredient. Such indication by the microcontroller 148 may be provided on the display 152 and/or audibly, and/or via the electronics device 156 via a display and/or audibly. In configurations, if a recipe is being followed and the recipe is included within, or at least being monitored by, the electronics device 156, then as ingredients are added and the appropriate amount of ingredient based upon weight has been reached, then the electronics device 156 may inform the user, via the UI component 150 and/or the GUI 154 and/or the electronics device 156, to begin adding a subsequent ingredient. Such indication by the may be provided on the display 152 and/or audibly.

Thus, in configurations, the microcontroller 148 may communicate with a computing device, e.g., the electronics device 156, either mobile or stationary, that includes the recipe being followed. Such communication may be either wired or wirelessly. The computing device thus may interact with the microcontroller 148 to control the addition of ingredients by weight to the blender cup 102 and the microcontroller 148 may communicate with the user via the computing device as to ingredients being added and the corresponding weights, as well as when to switch to other ingredients to be added to the blender cup 102.

The recipes generally include needed weights for various ingredients 104. The microcontroller 148 may include memory to store the recipes or the recipes may be stored elsewhere, such as, for example, a user's computing device, a central computing device or storage service, etc. The recipes may be provided to the microcontroller 148 from such computing devices when desired. Nutritional information may also be included within the recipes and displayed via the display 152, or on a display of the user's computing device, to the user of the mixing assembly 100. In configurations, the recipes may be based upon nutritional values. For example, a first ingredient may include an average nutritional value per unit of weight and a second ingredient may include another average nutritional value per unit of weight. The recipe may be written to provide a certain amount of nutritional value per serving and thus, the recipe may provide weights based upon a number of servings desired, a total amount of nutritional value desired, etc.

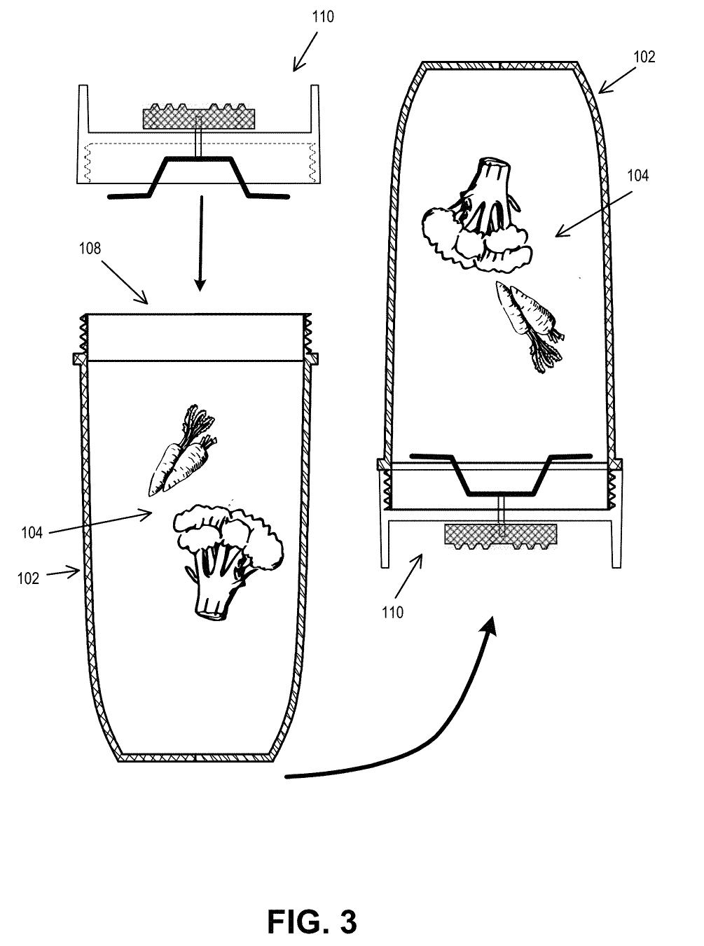

Referring to FIG. 3, once the ingredients 104 have been added to the blender cup 102, then the coupling unit 110 may be attached or coupled to the blender cup 102. As previously noted, in configurations, the coupling unit 110 may be coupled to the blender cup 102 by screwing the coupling unit 110 and the blender cup 102 relative to one another to thereby couple the coupling unit 110 to the blender cup 102 via the cooperating threads 140, 142. In other configurations, a snapping configuration may be provided wherein the coupling unit 110 is snapped to the blender cup 102. Additionally, the snapping configuration may be a type where the coupling unit 110 is placed on the blender cup 102 and then slightly twisted to lock the coupling unit 110 in place on the blender cup 102.

Once the coupling unit 110 is coupled to the blender cup 102, then the blender cup 102 and coupling unit 110 are moved vertically relative to the base 114 or inverted (as illustrated in FIG. 3) and placed on the base 114 of the mixing apparatus 100 as illustrated in FIG. 1A. The motor 144 may then be activated, either automatically or manually. As may be seen, the isolation walls 120 of the coupling unit 110 are adjacent to and may engage the isolation walls 154 of the base 114. This helps hold the blender cup 102 and coupling unit 110 in place during operation of the mixing apparatus 114.

As previously noted, the coupling clutch plate 116 engages the motor clutch plate 118 thereby operatively coupling the agitator 112 to the motor 144. Thus, when the motor 144 operates and rotates the axis 146, the motor clutch plate 118 rotates thereby rotating the coupling clutch plate 116. The rotation of the coupling clutch plate 116 rotates the axis 138 coupled to the agitator 112 to thereby rotate the agitator 112. Rotation of the agitator 112 thereby mixes and/or blends the ingredients 104 within the blender cup 102.

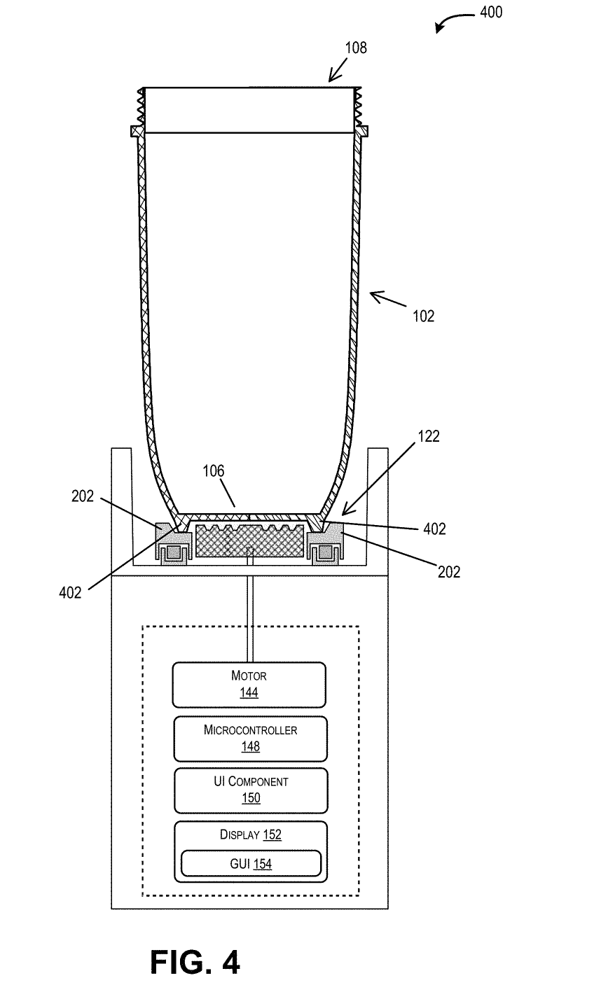

FIG. 4 schematically illustrates a configuration 400 of the mixing apparatus where the closed end 106 of the blender cup 102 includes an extended portion 402 that rests on the integrated scale 122. As can be seen, the extended portion 402 is adjacent to the raised portion 202 of the plate 124 and may help stabilize the blender cup 102 while ingredients 104 are added to the blender cup 102. Additionally, the extended portion 402 may help ensure that the closed end 106 of the blender cup 102 does not engage the motor clutch plate 118.

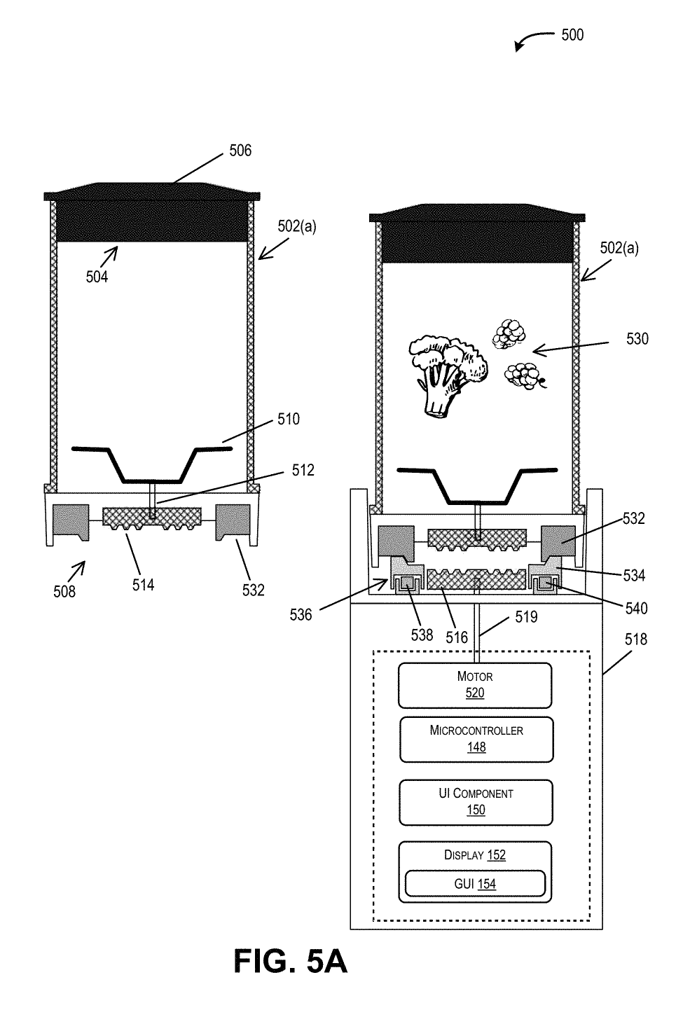

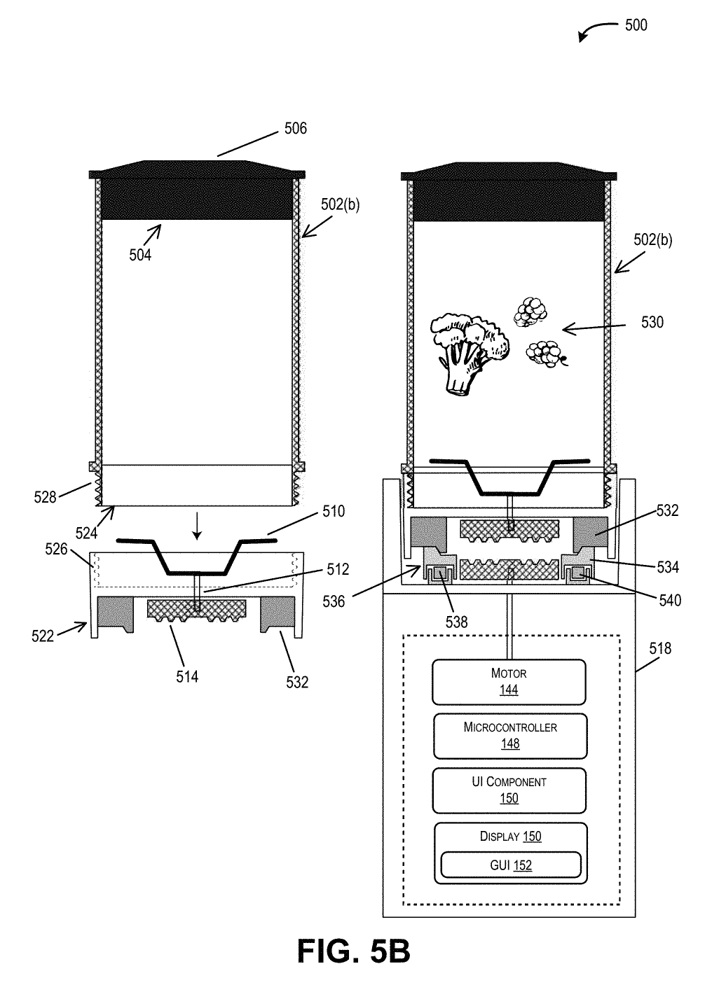

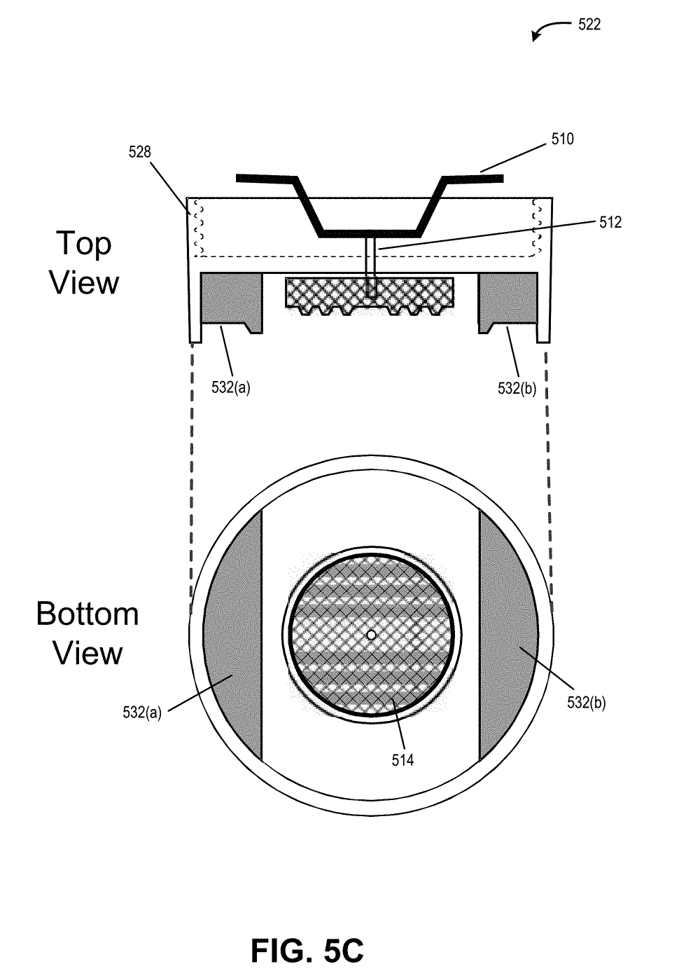

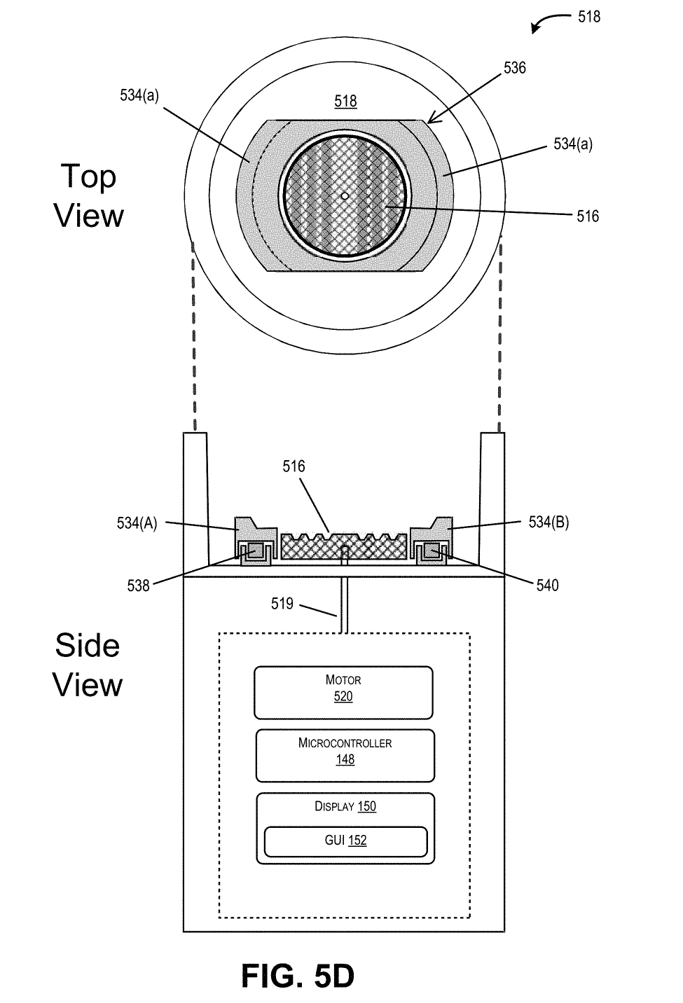

FIGS. 5A-5D illustrate a configuration of a mixing apparatus 500 in the form of a blender and thus, for the example configuration of FIGS. 5A-5D, the mixing apparatus will be referred to as blender 500. The blender 500 utilizes a vessel in the form of a blender jar 502a similar to conventional blender jars. The blender jar 502a includes an open end 504 that is configured to receive a lid 506. In configurations, as is known with blender jars, the opposite end 508 of the blender jar 502 includes an agitator 510 coupled to an axis 512 that is coupled to a blender clutch plate 514. In configurations, the agitator 510, axis 512 and blender clutch plate 514 may be removable, as is known with conventional blender jars.

The clutch plate 514 is configured for engagement with a motor clutch plate 516 of a base 518 of the blender 500. The motor clutch plate 516 is coupled to an axis 519 that is coupled to a motor 520 to rotate the motor clutch plate 516, which in turn rotates the blender clutch plate 514 and thereby the agitator 510, e.g., a blending blade or mixing blade. The base 518 is similar to the base 114 as previously described with respect to the example configurations of FIGS. 1-4 and thus, may also include one or more of a microcontroller 148, UI component 150, display 152 and/or GUI 154. The base 518 may also include one or more physical or manual controls (not illustrated). Additionally, an electronics device, e.g., the electronics device 156, may interact with the mixing apparatus 500 as previously described herein.

Referring to FIG. 5B, in configurations, the agitator 510, axis 512 and blender clutch plate 514 may be included within a coupling unit 522 similar to coupling unit 110. In such a configuration, the blender jar 502b is open at end 524. The coupling unit 522 may be secured to the blender jar 502b at the end 524 via cooperating threads 526, 528 on the blender jar 502b and the coupling unit 522, respectively. Alternatively, as previously described with reference to the example configurations of FIGS. 1-4, a snapping arrangement or a twist and lock arrangement may be utilized to couple the blender jar 502b and the coupling unit 522. Since the end 504 is open, the coupling unit 522 is coupled to the end 524 prior to adding any ingredients 530.

The blender jar 502a and the coupling unit 522 each further include a key 532 that may be utilized to engage a plate 534 of an integrated scale 536 so that ingredients 530 may be added to the blender jar 502a, 502b and weighed, as previously described with respect to FIGS. 1-4. The integrated scale 536 is similar to the integrated scale 122 described with respect to the example configurations of FIGS. 1-4.

Once the ingredients 530 have been added to the blender jar 502a, 502b, via the open end 504, the lid 506 may be placed over the blender jar 502a, 502b and the blender jar 502a, 502b may be moved horizontally relative to the base 518 or rotated, e.g., 45 to 90 degrees, such that the key 532 no longer engages the plate 534, as will be described with respect to FIGS. 5c and 5D. The blender jar 502a, 502b may then lower down onto the base 518 such that the blender clutch plate 514 engages the motor clutch plate 516.

FIG. 5C is a top and side view of the coupling unit 522 and illustrate an example of the arrangement of the key 532 on the coupling unit 522. Such an arrangement also corresponds to the bottom of the blender jar 502a. As can be seen, the key 532 includes two portions 532a, 532b that are located on two opposing sides of the bottom of the coupling unit 522. Likewise, the bottom of the blender jar 502a includes such a key 532 arranged in a similar fashion.

FIG. 5D is a top and side view of the base 518 and shows the arrangement of the plate 534, wherein the plate 534 includes two opposing portions 534a, 534b. Load cells 538 and 540 may be located, as can be seen in FIG. 5D, under respective plate portions 534a, 534b.

Thus, when the blender jar 502a and the blender jar 502b with the coupling unit 522 is placed on the plate portions 534a, 534b such that the key 532 engages the plate portions 534a, 534b, the plate portions 534a, 534b may be utilized to measure weights of ingredients 530 added to the blender jar 502a, 502b, as previously described with respect to the example configurations of FIGS. 1-4. When the blender jar 502a, 502b is moved horizontally relative to the base 518 or rotated, the key 532 will no longer engage the scale ring plate and will thus engage the base 518 of the mixing assembly 500. This lowers the blender jar 502a, 502b, thereby engaging the clutch plate 516 and 518 to allow for rotation of the agitator 510 via the motor 520.

In configurations, the blender cups 102 and blender jars 502 and/or coupling units 110, 522 may be configured such that the blender cups 102 and blender jars 502 can be moved in multiple directions, e.g., vertically and/or horizontally, with respect to the base 114, 518. Thus, the blender cups 102 and blender jars 502 may engage and disengage the integrated scale 122, 536, as well as engage and disengage the motor clutch plate 118, 516, by either moving vertically, horizontally, or a combination of both directions.

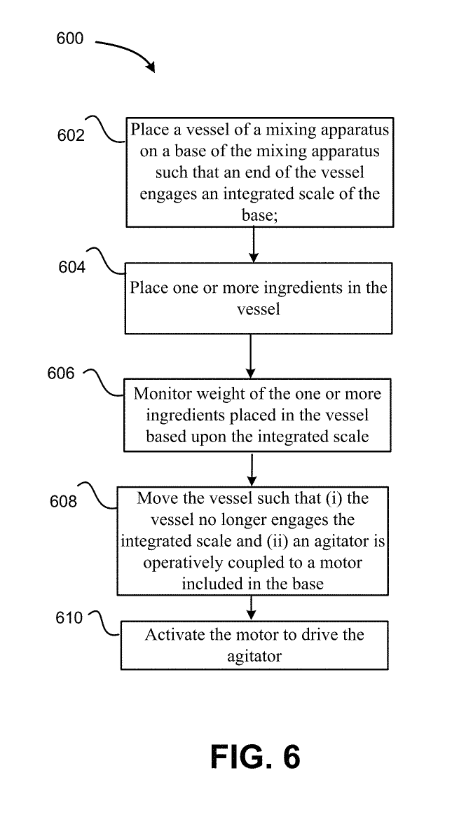

FIG. 6 is a flowchart illustrating an example method 600 of using a mixing apparatus, e.g., mixing apparatuses 100 and 500, to weigh and mix ingredients. At 602, a vessel, e.g., blender cup 102 or blender jar 502, of a mixing apparatus is placed on a base of the mixing apparatus such that an end of the vessel engages an integrated scale of the base. At 604, one or more ingredients is placed in the vessel. A recipe may provide an amount of the one or more ingredients and/or an order of the one or more ingredients to be placed in the vessel. The recipe may be stored in the mixing apparatus or in a separate electronics device, e.g., electronics device 156. At 606, weight of the one or more ingredients placed in the vessel is monitored based upon the integrated scale. Information such as the weight may be provided to a user of the mixing apparatus via a UI of the mixing apparatus. Additionally, other information, e.g., nutritional information, may also be provided to the user of the mixing apparatus via the UI, in addition to or instead of the weight. Such information may also be provided to the separate electronics device. At 608, the vessel is moved such that (i) the vessel no longer engages the integrated scale and (ii) an agitator is operatively coupled to a motor included in the base. At 610, the motor is activated to drive the agitator.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. An apparatus comprising:
a base comprising:
an integrated scale comprising a load cell; and
a motor;
a coupling unit comprising an agitator; and
a vessel, wherein the vessel comprises:
a first end that includes an opening configured for coupling to the coupling unit; and
a second end configured for engagement with the integrated scale,
wherein the coupling unit is configured to engage the vessel with the base such that the integrated scale does not engage the coupling unit, and
wherein the coupling unit is configured to engage the vessel with the base such that the motor is operatively coupled to the agitator.

2. The apparatus of claim 1, wherein:
the base further comprises a motor clutch plate operatively coupled to the motor; and
the coupling unit further comprises a coupling clutch plate configured for engagement with the motor clutch plate to operatively couple the motor to the agitator.

3. The apparatus of claim 1, wherein the first end and the coupling unit each comprise cooperating threads that allow the coupling unit to be coupled to the first end of the vessel.

4. The apparatus of claim 1, wherein the first end and the coupling unit are configured to be snapped together such that the coupling unit may be coupled to the first end of the vessel.

5. The apparatus of claim 1, wherein the integrated scale further comprises a ring plate that includes a seat for receiving the second end of the vessel.

6. The apparatus of claim 5, wherein the vessel comprises a mixing cup that includes a raised ring configured for engaging the seat of the ring plate.

7. The apparatus of claim 1, wherein the integrated scale comprises at least two load cells, wherein a first and a second load cell are located opposite one another.

8. The apparatus of claim 7, wherein the integrated scale comprises at least four load cells, wherein a third and fourth load cell are located opposite one another.

9. The apparatus of claim 1, wherein:
the integrated scale further comprises a ring plate that includes a seat for receiving the second end of the vessel; and
the load cell comprises a ring shape corresponding to the ring plate.

10. The apparatus of claim 1, further comprising a user interface component to provide information that includes at least one of (1) measurements from the scale as ingredients are placed in the vessel, (2) recipe steps to follow as ingredients are placed in the vessel, or (3) instructions to operate the apparatus.

11. The apparatus of claim 10, wherein the user interface component comprises at least one of an audio component, a visual component, or a combination of audio and visual components.

12. The apparatus of claim 10, wherein the user interface component comprises a display mounted in the base and a graphical user interface presented on the display.

13. The apparatus of claim 10, wherein the user interface component comprises a graphical user interface configured to execute on an electronics device independent of, but communicatively coupled to, the base.

14. A mixing apparatus comprising:
a base comprising:
an integrated scale comprising a load cell; and
a motor;
an agitator; and
a vessel,
wherein the vessel is configured for (i) engagement with the integrated scale and (ii) operative coupling of the agitator with the motor,
wherein the vessel is configured such that when the vessel engages the integrated scale, the motor is not operatively coupled to the agitator, and
wherein the vessel is configured such that when the motor is operatively coupled to the agitator, the vessel does not engage the integrated scale.

15. The mixing apparatus of claim 14, wherein:
an end of the vessel comprises the agitator coupled thereto;
the vessel further comprises another end having an opening defined therein;
the mixing apparatus further comprises a lid configured for engagement with the another end; and
the mixing apparatus is configured such that when the end engages the integrated scale, movement of the vessel in a horizontal direction relative to the base causes the end to disengage the integrated scale and operatively couple the agitator to the motor.

16. The mixing apparatus of claim 14, further comprising a coupling unit comprising the agitator and wherein the vessel comprises:
an end that includes an opening configured for coupling to the coupling unit,
wherein the coupling unit is configured to engage the vessel with the base such that when the coupling unit engages the integrated scale, the agitator is not operatively coupled to the motor.

17. The mixing apparatus of claim 16, wherein:
the base further comprises a motor clutch plate coupled to the motor; and
the coupling unit further comprises a coupling clutch plate configured for engagement with the motor clutch plate to operatively couple the motor to the agitator.

18. The mixing apparatus of claim 16, wherein the end and the coupling unit each comprise cooperating threads that allow the coupling unit to be coupled to the end of the vessel.

19. The mixing apparatus of claim 16, wherein the end and the coupling unit are configured to be snapped together such that the coupling unit may be coupled to the end of the blending cup.

20. The mixing apparatus of claim 16, wherein the integrated scale further comprises a ring plate that includes a seat for receiving another end of the blending cup.

21. The mixing apparatus of claim 20, wherein the vessel includes a raised ring at the another end configured for engaging the seat of the ring plate.

22. The mixing apparatus of claim 14, wherein:
the integrated scale comprises at least two load cells; and
a first and a second load cell are located opposite one another.

23. The mixing apparatus of claim 22, wherein:
the integrated scale comprises at least four load cells; and
a third and fourth load cell are located opposite one another.

24. The mixing apparatus of claim 14, further comprising multiple vessels of differing sizes.

25. A system comprising:
a base to support a vessel configured to hold one or more ingredients, the base comprising:
a motor to couple to the vessel to mix the one or more ingredients when the vessel is coupled to the motor; and
an integrated scale integrated into the base to provide measurements associated with the one or more ingredients in the vessel; and
a user interface to communicate with a user of the system, the user interface providing information to the user associated with the one or more ingredients in the vessel.

26. The system of claim 25, wherein the integrated scale comprises a ring plate.

27. The system of claim 26, wherein the ring plate comprises a seat for receiving an end of the vessel.

28. The system of claim 25, wherein the information provided to the user by the user interface comprises at least one of (1) measurements from the scale as the one or more ingredients are placed in the vessel, (2) recipe steps to follow as the one or more ingredients are placed in the vessel, or (3) instructions to operate the system.

29. The system of claim 25, wherein the user interface comprises at least one of an audio component, a visual component, or a combination of audio and visual components.

30. The system of claim 25, wherein the user interface comprises a display mounted in the base and a graphical user interface presented on the display.

31. The system of claim 10, wherein the user interface comprises a graphical user interface configured to execute on an electronics device independent of, but communicatively coupled to, the base.

32. The system of claim 25, wherein the user interface is integrated into the base.

33. A method comprising:
placing a vessel of a mixing apparatus on a base of the mixing apparatus such that an end of the vessel engages an integrated scale of the base;
placing one or more ingredients in the vessel;
monitoring weight of the one or more ingredients placed in the vessel based upon the integrated scale;
moving the vessel such that (i) the vessel no longer engages the integrated scale and (ii) an agitator is operatively coupled to a motor included in the base; and
activating the motor to drive the agitator.

34. The method of claim 33, wherein moving the vessel comprises moving the vessel in a horizontal direction relative to the base.

35. The method of claim 33, wherein moving the vessel comprises:
placing a coupling unit over another end of the vessel, wherein the another end is opposite to the end, and wherein the coupling unit comprises the agitator; and
operatively coupling the agitator with the motor by moving the vessel in a vertical direction relative to the base.

36. The method of claim 35, wherein operatively coupling the agitator to the motor comprises:
engaging a coupling clutch plate of the coupling unit with a motor clutch plate operatively coupled to the motor.

37. The method of claim 35, wherein placing the coupling unit over the another end of the vessel comprises rotating at least one of the coupling unit or the vessel relative to each other such that cooperating threads on each of the coupling unit and the vessel couple the coupling unit to the another end of the blending cup.

38. The method of claim 35, wherein placing the coupling unit over the another end of the vessel comprises snapping the coupling unit and the vessel to each other to thereby couple the coupling unit to the another end of the blending cup.
